(19) United States
(12) Patent Application Publication
(10) Pub. No.: US 2026/0184585 A1
(43) Pub. Date: Jul. 2, 2026

(54) INORGANIC COMPOUND PARTICLE PRODUCING APPARATUS

(71) Applicant: Panasonic Intellectual Property Management Co., Ltd., Osaka (JP)

(72) Inventors: SHINNOSUKE AKIYAMA, Osaka (JP); TAICHI NAKAMURA, Osaka (JP); YONGSHIN LEE, Osaka (JP)

(21) Appl. No.: 19/419,193

(22) Filed: Dec. 15, 2025

(30) Foreign Application Priority Data
Dec. 27, 2024 (JP) 2024-232721

(51) Int. Cl. C01F 7/54

(52) U.S. Cl. CPC C01F 7/54

(57) ABSTRACT

An inorganic compound particle producing apparatus includes: a first raw material supply unit that supplies a first solution and a second solution; a first mix unit including a first mixer that mixes the first solution and the second solution supplied from the first raw material supply unit to generate a mixed solution; a second raw material supply unit that supplies a first solution and a second solution; and a second mix unit located downstream of the first mix unit, the second mix unit mixing the first solution and the second solution supplied from the second raw material supply unit with the mixed solution supplied from the first mixer.

### BACKGROUND

### 1. Technical Field

The present disclosure relates to an inorganic compound particle producing apparatus using a microchannel.

### 2. Description of the Related Art

Conventionally, inorganic compound particles are used in various applications, and are produced by various production methods in order to obtain inorganic compound particles having a desired particle size according to the application. For example, a crystal producing apparatus including a reaction tank in which a crystalline compound is crystallized, a sedimentation separator that classifies crystals on a large particle diameter side and crystals on a small particle diameter side by sedimentation separation, and a filter that filters and concentrates the crystals is known (refer to, for example, PTL 1).

### Citation List

### Patent Literature

PTL 1: Japanese Patent No. 7,235,494

### SUMMARY

An inorganic compound particle producing apparatus according to the present disclosure includes: a first raw material supply unit that supplies a first solution and a second solution; a first mix unit including a first mixer that mixes the first solution and the second solution supplied from the first raw material supply unit to generate a mixed solution; a second raw material supply unit that supplies a first solution and a second solution; and a second mix unit located downstream of the first mix unit, the second mix unit mixing the first solution and the second solution supplied from the second raw material supply unit with the mixed solution supplied from the first mixer.

### BRIEF DESCRIPTION OF THE DRAWINGS

FIG. 1A is a schematic view showing a configuration of an inorganic compound particle producing apparatus according to a first exemplary embodiment;

FIG. 1B is a schematic view showing a change in particle size of inorganic compound particles before and after an additional second solution is supplied in the third mixer in FIG. 1;

FIG. 1C is a schematic view showing a particle size distribution and a range of particle size control of inorganic compound particles obtained by the inorganic compound particle producing apparatus according to the first exemplary embodiment;

FIG. 2 is Table 1 showing production conditions of inorganic compound particles of Examples 1 to 6 using the inorganic compound particle producing apparatus of FIG. 1A and Comparative Examples 1 to 3 and properties of the obtained inorganic compound particles;

FIG. 3 is a schematic view showing a configuration of an inorganic compound particle producing apparatus according to a second exemplary embodiment; and

FIG. 4 is Table 2 showing production conditions of inorganic compound particles of Examples 7 to 10 using the inorganic compound particle producing apparatus of FIG. 3 and Comparative Examples 4 to 5 and properties of the obtained inorganic compound particles.

### DETAILED DESCRIPTIONS

In the conventional crystal producing apparatus, it is difficult to perform a classification operation of particles having a particle size of several μm, and the classification operation is substantially limited to particles having a particle size of 10 μm or more, and it is not possible to obtain inorganic compound particles having a smaller particle size of nm units.

Therefore, an object of the present disclosure is to provide an inorganic compound particle producing apparatus capable of producing inorganic compound particles having a particle size of nm units. An inorganic compound particle producing apparatus according to a first aspect includes: a first raw material supply unit that supplies a first solution and a second solution; a first mix unit including a first mixer that mixes the first solution and the second solution supplied from the first raw material supply unit to generate a mixed solution; a second raw material supply unit that supplies a first solution and a second solution; and a second mix unit located downstream of the first mix unit, the second mix unit mixing the first solution and the second solution supplied from the second raw material supply unit with the mixed solution supplied from the first mixer.

In an inorganic compound particle producing apparatus according to a second aspect, in the first aspect, the second raw material supply unit may separately supply the first solution and the second solution to the second mix unit.

In an inorganic compound particle producing apparatus according to a third aspect, in the second aspect, the second mix unit may include a second mixer located downstream of the first mix unit, the second mixer mixing the first solution supplied from the second raw material supply unit, and a third mixer located downstream of the second mixer, the third mixer mixing the second solution supplied from the second raw material supply unit.

In an inorganic compound particle producing apparatus according to a fourth aspect, in the first aspect, the second raw material supply unit may supply, to the second mix unit, a mixed solution obtained by mixing the first solution and the second solution to have a concentration less than or equal to a saturation concentration.

In the first to fourth aspects, an inorganic compound particle producing apparatus according to a fifth aspect may further include: a detection evaluation unit located downstream of the second mix unit, the detection evaluation unit detecting an average particle size of inorganic compound particles generated and precipitated by a reaction between the first solution and the second solution supplied from the first raw material supply unit and the second raw material supply unit; and a controller that changes a concentration or a supply amount of at least one of the first solution and the second solution supplied from at least one of the first raw material supply unit and the second raw material supply unit based on the average particle size of the inorganic compound particles detected by the detection evaluation unit.

In an inorganic compound particle producing apparatus according to a sixth aspect, in the first to fourth aspects, the first solution supplied from each of the first raw material supply units and the second raw material supply unit may be a solution in which a first compound including fluorine and an alkali metal element is dissolved, the second solution supplied from each of the first raw material supply units and the second raw material supply unit may be a solution in which a second compound including at least one metal element selected from the group consisting of an alkaline earth metal element, aluminum, gallium, indium, zinc, and yttrium is dissolved, and the inorganic compound particles may be complex fluoride composite particles.

Hereinafter, an inorganic compound particle producing apparatus according to exemplary embodiments of the present disclosure will be described with reference to the accompanying drawings. However, unless otherwise specified, the constituent elements, types, combinations, shapes, relative positions, and the like described in the exemplary embodiment are not intended to limit the scope of the present disclosure only thereto, and are merely illustrative examples.

### First Exemplary Embodiment

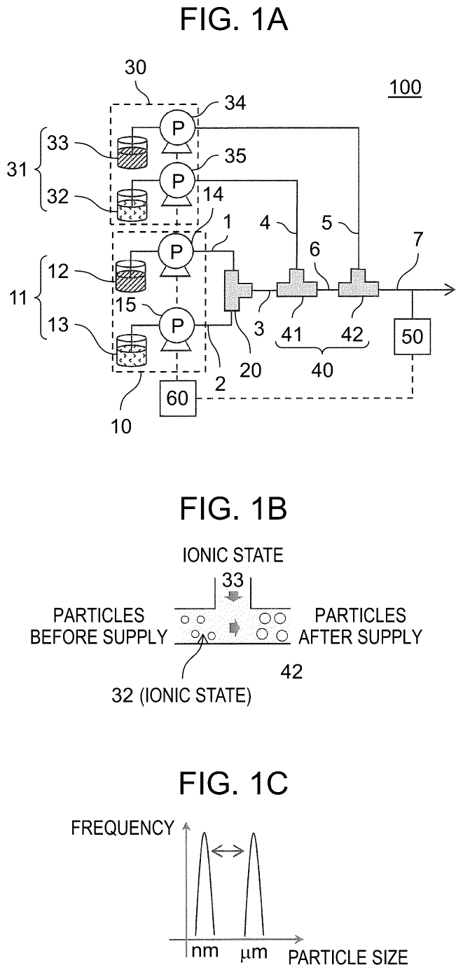

FIG. 1A is a schematic view showing a configuration of inorganic compound particle producing apparatus 100 according to a first exemplary embodiment.

Inorganic compound particle producing apparatus 100 according to the first exemplary embodiment includes: first raw material supply unit 10 that supplies first solution 12 and second solution 13; first mix unit (first mixer) 20 that mixes first solution 12 and second solution 13, second raw material supply unit 30 that supplies first solution 32 and second solution 33, and second mix unit 40 that mixes first solution 32 and second solution 33 with the mixed solution on the downstream side of first mix unit 20.

This inorganic compound particle producing apparatus 100 further includes second mix unit 40 on the downstream side of first mix unit 20. As a result, the average particle size can be increased while the particle size distribution of the inorganic compound particles generated in first mix unit 20 remains narrow, and the particle size can be controlled from the particle size of nm to the particle size of μm.

Hereinafter, each member constituting inorganic compound particle producing apparatus 100 will be described.

### <First Raw Material Supply Unit>

First raw material supply unit 10 supplies first solution 12 and second solution 13 to first mix unit 20. First solution 12 and second solution 13 are respectively supplied via, for example, first liquid supply unit 14 and second liquid supply unit 15 through first flow path 1 and second flow path 2, respectively. First solution 12 and second solution 13 supplied by first raw material supply unit 10 may be collectively referred to as first raw material group 11.

### <Liquid Supply Unit>

First liquid supply unit 14 and second liquid supply unit 15 may be able to supply first solution 12 and second solution 13, respectively, and are configured by liquid supply devices such as a syringe pump, a plunger pump, a diaphragm pump, a tube pump, a Mono pump, or a piezo pump.

### <Flow Path>

Materials of first flow path 1 and second flow path 2 are not particularly limited, and for example, an inorganic material such as glass, quartz, ceramics, or silicon, or a resin material such as a thermoplastic resin or a thermosetting resin can be used. The inner diameters of first flow path 1 and second flow path 2 are, for example, between 0.1 mm and 1.59 mm, inclusive, but are not limited thereto.

In FIG. 1A, first solution 12 and second solution 13 are respectively supplied to first flow path 1 and second flow path 2 communicating from first liquid supply unit 14 and second liquid supply unit 15, respectively. For example, first solution 12 of a first compound that is an alkali metal fluoride is supplied to first flow path 1, and second solution 13 of a second compound having a metal element different from the alkali metal fluoride is supplied to second flow path 2.

### <First Solution>

First solution 12 is, for example, a solution of a first compound that is an alkali metal fluoride. Examples of the alkali metal element included in the first compound include lithium, sodium, potassium, rubidium, or cesium. Specifically, the first compound may include at least one alkali metal element selected from the group consisting of lithium fluoride, sodium fluoride, potassium fluoride, rubidium fluoride, and cesium fluoride.

In first flow path 1, first solution 12 is supplied at a concentration that does not reach supersaturation. As a result, the first compound included in first solution 12 is not precipitated in first flow path 1. In addition, the concentration of first solution 12 is set to a concentration at which the mixed solution of first solution 12 and second solution 13 is supersaturated when first solution 12 is mixed with second solution 13 in first mix unit 20. Specifically, for example, the concentration of the first compound is set to a range between 40 mM and 640 mM, inclusive, after mixing first solution 12 and second solution 13.

In the figure, first solution 12 is stored in the tank, but this is an example, and the present disclosure is not limited thereto.

### <Second Solution>

Second solution 13 is a solution of a second compound having a metal element different from the alkali metal fluoride. The second compound is at least one selected from the group consisting of a metal chloride, a metal nitrate, a metal sulfate, and a metal organic acid salt, and may include a metal salt excluding a metal fluoride. The metal element included in the second compound may be at least one selected from the group consisting of an alkaline earth metal element, aluminum, gallium, indium, zinc, and yttrium. The second compound may include, for example, aluminum chloride.

In second flow path 2, second solution 13 is supplied at a concentration that does not reach supersaturation. As a result, the second compound included in second solution 13 is not precipitated in second flow path 2. In addition, the concentration of second solution 13 is set to a concentration at which the mixed solution of first solution 12 and second solution 13 is supersaturated when second solution 13 is mixed with first solution 12 in first mix unit 20. Specifically, for example, the concentration of the second compound is set to be less than or equal to 1/20 with respect to the concentration of the first compound after mixing the first solution and the second solution.

The concentration of each of first solution 12 and second solution 13 to be mixed in first mix unit 20 may be set in a stoichiometric ratio for the inorganic compound particles to be generated, but is not limited thereto. For example, the concentration of one of first solution 12 and second solution 13 may be set to be excessive or insufficient from the stoichiometric ratio. Specifically, the concentration of first solution 12 may be set to be insufficient from the stoichiometric ratio, or the concentration of second solution 13 may be set to be excessive from the stoichiometric ratio. As described above, when only first solution 32 is mixed in second mixer 41, the particle growth of the inorganic compound particles already generated can be promoted.

In the figure, second solution 13 is stored in the tank, but this is an example, and the present disclosure is not limited thereto.

### <First Mix Unit (First Mixer)>

First mix unit 20 is configured by a first mixer that mixes first solution 12 and second solution 13 of first raw material group 11. First solution 12 supplied through first flow path 1 and second solution 13 supplied through second flow path 2 are mixed in first mixer 20 to form a mixed solution, and the mixed solution is supplied to third flow path 3. The mixed solution is supersaturated, and in the mixed solution, inorganic compound particles are generated and precipitated.

The first mix unit (first mixer) 20 may be able to mix a plurality of liquids, and includes, for example, a flow path connecting member such as one made by bonding or laminating and fixing a plurality of flat plates to a flat plate provided with a union tee or a manifold of a pipe joint, grooves, or through holes. Specifically, for example, a T-shaped mixer, a three-way joint, or the like may be used.

### <Second Raw Material Supply Unit>

Second raw material supply unit 30 supplies first solution 32 and second solution 33 to second mix unit 40 on the downstream side of first mix unit 20. In the first exemplary embodiment, as shown in FIG. 1A, first solution 32 and second solution 33 are separately supplied to second mix unit 40. First solution 32 and second solution 33 are respectively supplied via, for example, third liquid supply unit 34 and fourth liquid supply unit 35 through fourth flow path 4 and fifth flow path 5, respectively. First solution 32 and second solution 33 supplied by second raw material supply unit 30 may be collectively referred to as second raw material group 31.

Similarly to first raw material supply unit 10, second raw material supply unit 30 can set the concentration of first solution 32 and second solution 33, or can lower the concentration thereof by supplying pure water.

When the average particle size of the obtained inorganic compound particles is detected and feedback control is performed based on the detected average particle size by detection evaluation unit 50 and controller 60 to be described later, at least one of the concentration and the supply amount of at least one of first solution 12 of first raw material group 11, second solution 13 of first raw material group 11, first solution 32 of second raw material group 31, and second solution 33 of second raw material group 31 may be changed. For example, when inorganic compound particles having a desired particle size or more are already generated, at least one of the concentration and the flow rate of at least one of first solution 12 and second solution 13 of first raw material group 11 may be controlled. When the particle size of the generated inorganic compound particles does not reach the desired particle size, at least one of the concentration and the flow rate of at least one of first solution 32 and second solution 33 of second raw material group 31 may be changed by controlling at least one of third liquid supply unit 34 and fourth liquid supply unit 35.

### <Second Mix Unit>

FIG. 1B is a schematic view showing a change in particle size of inorganic compound particles before and after an additional second solution 33 is supplied in third mixer 42 in FIG. 1. FIG. 1C is a schematic view showing a particle size distribution and a range of particle size control of inorganic compound particles obtained by inorganic compound particle producing apparatus 100 according to the first exemplary embodiment.

Second mix unit 40 mixes first solution 32 and second solution 33 of second raw material group 31 supplied from second raw material supply unit 30 with the mixed solution of first solution 12 and second solution 13 of first raw material group 11 on the downstream side of first mix unit 20. In the first exemplary embodiment, as shown in FIG. 1A, first solution 32 and second solution 33 are separately and sequentially supplied to second mix unit 40. In this case, second mix unit 40 includes two second mixer 41 and third mixer 42 that sequentially mix first solution 32 and second solution 33. That is, in second mixer 41, only first solution 32 is mixed and supplied to sixth flow path 6 in a mixed state of the inorganic compound particles already generated and the added first solution 32. In this case, no new particles are generated. In third mixer 42, second solution 33 is mixed. In this case, second solution 33 is added to the mixed state of the inorganic compound particles and first solution 32, and thus there is a possibility of generation of new inorganic compound particles by first solution 32 and second solution 33 and a possibility of particle growth on the surface of the already existing inorganic compound particles. At less than or equal to the degree of supersaturation in which nucleation occurs, it is considered that first solution 32 is dispersed around the inorganic compound particles present as shown in FIG. 1B, and thus the particles can be grown on the surface of the inorganic compound particles by first solution 32 and second solution 33.

In addition, in this case, as shown in FIG. 1C, the particle growth is performed in the microchannel, and thus particles having a narrow particle size distribution can be generated. Further, the inorganic compound particles generated first can be grown while maintaining a narrower particle size distribution, and the average particle size can be controlled in a wide range from a nm level to a μm level.

In a second exemplary embodiment described later, a case where the first solution and the second solution are supplied to the second mix unit as a mixed solution is described. In this case, the second mix unit is configured by one second mixer.

As second mixer 41 or third mixer 42, a mixer similar to the first mixer can be used, but the present disclosure is not limited thereto, and another mixer may be used. In addition, in the first exemplary embodiment, second mix unit 40 is configured by two mixers 41, 42, but the first exemplary embodiment is not limited thereto. For example, the second mix unit may be configured by three or more mixers. In this case, for example, at least one of the first solution and the second solution may be mixed a plurality of times, or the first solution and the second solution may be alternately and sequentially mixed. As described above, performing particle growth a plurality of times using three or more mixers allows the average particle size to be controlled over a wide range while keeping the particle size distribution narrower.

### <Detection Evaluation Unit>

Detection evaluation unit 50 that detects the average particle size of the inorganic compound particles generated and precipitated by the reaction between the first solution and the second solution may be provided. The average particle size may be indicated by, for example, a median diameter D50 represented as a particle diameter at a cumulative frequency of 50% in a particle size distribution obtained from a particle diameter histogram. In this case, detection evaluation unit 50 may obtain a histogram of the particle size of the inorganic compound particles.

### <Controller>

Inorganic compound particle producing apparatus 100 may be provided with controller 60 that changes a supply condition of at least one of a concentration and a supply amount of at least one of the first solution and the second solution supplied from at least one of first raw material supply unit 10 and second raw material supply unit 30 based on the average particle size of the inorganic compound particles detected by detection evaluation unit 50.

For example, in a case where inorganic compound particles having a desired particle size or more are already generated, the particles are grown in two stages, and thus the liquid supply flow rates of first solution 12 and second solution 13 in first raw material group 11 may be controlled. Alternatively, when the inorganic compound particles having a desired particle size or more are not generated, the liquid supply flow rate of second raw material group 31 may be controlled.

### <Recovery and Separation Unit>

A recovery and separation unit (not shown) for collecting the obtained inorganic compound particles may be provided on the downstream side of second mix unit 40 and detection evaluation unit 50 provided as necessary. The inorganic compound particles generated by the recovery and separation unit are separated and recovered. The inorganic compound particles are separated by, for example, a method of solid-liquid separation from a solution. The method of solid-liquid separation is not particularly limited, and for example, filtration or centrifugation can be used.

When the second compound is a metal chloride, a metal nitrate, a metal sulfate, or a metal organic acid salt, a chloride, a nitrate, a sulfate, or a metal organic acid salt of an alkali metal element is generated as a by-product in addition to the inorganic compound particles at the time of mixing the first compound and the second compound. Therefore, a washing operation for removing by-products may be performed. The alkali metal compound may be removed, for example, by washing with a solvent such as water at the time of filtration or centrifugation operation.

Inorganic compound particle producing apparatus 100 according to the first exemplary embodiment can produce inorganic compound particles having a particle size in nm units, does not require a classification operation, and has simple operation management.

Next, the obtained inorganic compound particles will be exemplified.

### <Inorganic Compound Particles>

The inorganic compound particles according to the first exemplary embodiment may be, for example, complex fluoride composite particles. The complex fluoride composite may include an alkali metal element. The complex fluoride may include, for example, at least one alkali metal element selected from the group consisting of lithium, sodium, potassium, rubidium, and cesium.

The complex fluoride composite may include fluorine, an alkali metal element, and an additional metal element other than the alkali metal element as a main ingredient. The additional metal element may include at least one metal selected from the group consisting of an alkaline earth metal, aluminum, gallium, indium, zinc, and yttrium. Specifically, the additional metal element may include at least one metal selected from the group consisting of magnesium, calcium, strontium, barium, aluminum, gallium, indium, zinc, and yttrium. A molded body of the complex fluoride including these metal elements can easily lead to production by, for example, a pressure heating method. The term “main ingredient” as used herein means that the total content of fluorine, the alkali metal element, and the additional metal element included in the complex fluoride is 80% or more in terms of molar ratio. The total content may be 85% or more, 90% or more, 95% or more, or 100%.

Specifically, the complex fluoride composite may include at least one of A₃AlF₆ and ABF₃ (herein, in the composition formula, A represents one or more alkali metal elements described above, and B represents one or more alkaline earth metal elements described above). A₃AlF₆ may include, for example, at least one selected from the group consisting of Li₃AlF₆, Li₂NaAlF₆, Li₂KAlF₆, Na₃AlF₆, Na₂LiAlF₆, Na₂KAlF₆, K₃AlF₆, K₂LiAlF₆, and K₂NaAlF₆. ABF₃ may include, for example, at least one selected from the group consisting of LiMgF₃, NaMgF₃, KMgF₃, LiCaF₃, NaCaF₃, and KCaF₃. More specifically, the complex fluoride composite may include at least one selected from the group consisting of Na₃AlF₆ and NaMgF₃.

The complex fluoride composite may include fluorine, an alkali metal element, and aluminum as main ingredients. The term “main ingredient” as used herein means that the total content of fluorine, the alkali metal element, and aluminum included in the complex fluoride is 80% or more in terms of molar ratio. The total content may be 85% or more, 90% or more, 95% or more, or 100%.

A part of constituent anions of the complex fluoride composite may be substituted by hydroxide ions or oxide ions. For example, in the case of a complex fluoride synthesized in the liquid phase, a part of the complex fluoride ions may be substituted with at least one of hydroxide ions and oxide ions.

### Examples 1 to 6 and Comparative Examples 1 to 4

Hereinafter, Examples using inorganic compound particle producing apparatus 100 according to the first exemplary embodiment and Comparative Examples, in which sodium hexafluoroaluminate (Na₃AlF₆) as a complex fluoride was produced as inorganic compound particles will be described.

### Example 1

In Example 1, two types of compound solutions were supplied using two plunger pumps as the liquid supply unit of first raw material supply unit 10. Herein, as a compound solution for synthesizing Na₃AlF₆ as inorganic compound particles, first solution 12 in which sodium fluoride as a first compound was dissolved in ultrapure water at 48 mM and second solution 13 in which aluminum chloride hexahydrate as a second compound was dissolved in ultrapure water at 40 mM were prepared. Then, the flow rate ratio of second solution 13 to first solution 12 was set to ⅕, and the set flow rate of each plunger pump was adjusted such that the flow rate of the mixed solution was 10 mL/min (flow rate of first solution 12: flow rate of second solution 13=5:1). In the case of the above flow rate, the concentration of the first compound in the mixed solution after mixing the two liquids was 40 mM.

A T-shaped mixer (SUS316 material, inner diameter 0.5 mm) was used as first mixer 20 for first solution 12 and second solution 13.

Two plunger pumps were also used for the liquid supply unit of second raw material supply unit 30. Incidentally, first solution 32 obtained by dissolving sodium fluoride as the first compound in ultrapure water at 48 mM and second solution 33 obtained by dissolving aluminum chloride hexahydrate as the second compound at 40 mM are supplied from second raw material supply unit 30. In this case, the flow rate ratio of second solution 33 to first solution 32 is ⅕ (flow rate of first solution 32: flow rate of second solution 33=5:1), and if only second solution 33 is mixed, the flow rate is 10 mL/min, and the concentration of the first compound in the mixed solution is 40 mM.

When first solution 32 and second solution 33 are sequentially mixed, a T-shaped mixer (SUS316 material, inner diameter 0.5 mm) is used as second mixer 41 and third mixer 42 of second mix unit 40.

The solution mixed in third mixer 42 of second mix unit 40 passed through a particle detection unit (particle size evaluation unit) provided downstream, and the particle size was evaluated. In Example 1, the target average particle size (D50) was set to 10 μm, and feedback control was performed by controller 60 to adjust the liquid supply flow rate.

### Example 2

In Example 2, inorganic compound particles were fabricated under the same production conditions as in Example 1 except that first solution 12 obtained by dissolving the first compound in ultrapure water at 768 mM and second solution 13 obtained by dissolving the second compound in ultrapure water at 640 mM were used as first raw material group 11. The concentration of the first compound in the solution obtained by mixing first solution 12 and second solution 13 of first raw material group 11 was 640 mM. In addition, in Example 2, the target particle size was set to 250 nm.

### Example 3

In Example 3, inorganic compound particles were fabricated under the same production conditions as in Example 1 except that feedback control was not performed.

### Example 4

In Example 4, inorganic compound particles were fabricated under the same production conditions as in Example 2 except that feedback control was not performed.

### Example 5

In Example 5, inorganic compound particles were fabricated under the same production conditions as in Example 1 except that first solution 12 obtained by dissolving the first compound in ultrapure water at 192 mM and second solution 13 obtained by dissolving the second compound in ultrapure water at 160 mM were used as first raw material group 11. The concentration of the first compound in the solution obtained by mixing first solution 12 and second solution 13 of first raw material group 11 was 160 mM. In addition, in Example 5, the target particle size was set to 500 nm.

### Example 6

In Example 6, inorganic compound particles were fabricated under the same production conditions as in Example 5 except that feedback control was not performed.

### Comparative Example 1

In Comparative Example 1, inorganic compound particles were fabricated under the same production conditions as in Example 1 except that the feedback control was not performed and second raw material group 31 was not used.

### Comparative Example 2

In Comparative Example 2, inorganic compound particles were fabricated under the same production conditions as in Example 2 except that the feedback control was not performed and second raw material group 31 was not used.

### Comparative Example 3

In Comparative Example 3, inorganic compound particles were fabricated under the same production conditions as in Example 5 except that the feedback control was not performed and second raw material group 31 was not used.

### Evaluation

A case where the deviation of the particle size evaluation value (average particle size) from the target set particle size was within 5% of the target set particle size was evaluated as ⊙, a case where the deviation of the particle size evaluation value from the target set particle size was within 5 to 10% of the target set particle size was evaluated as ◯, and other cases were evaluated as x.

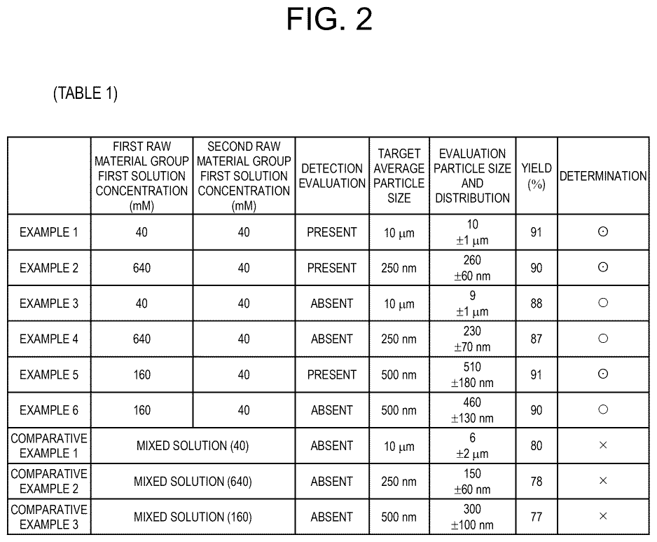

FIG. 2 is Table 1 showing production conditions of inorganic compound particles of Examples 1 to 6 using inorganic compound particle producing apparatus 100 of FIG. 1A and Comparative Examples 1 to 3 and properties of the obtained inorganic compound particles.

As shown in Table 1 of FIG. 2, in the cases of Examples 1 to 6 using inorganic compound particle producing apparatus 100 having second mix unit 40 in addition to first mix unit 20, it is found that the target average particle size could be achieved within an error range. In contrast, in the cases of Comparative Examples 1 to 3 using inorganic compound particle producing apparatus 100 without providing second mix unit 40, the target average particle size could not be achieved within an error range.

In addition, comparing Examples 1, 2, and 5 with Examples 3, 4, and 6, it is found that the average particle size of the obtained particles is closer to the target average particle size in consideration of the error and the yield is higher in the case of performing the feedback control using detection evaluation unit 50 and controller 60.

### Second Exemplary Embodiment

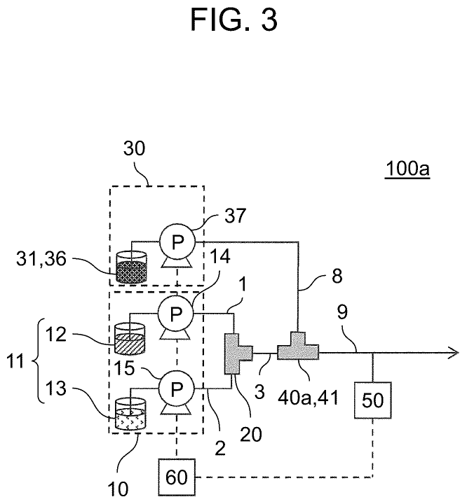

FIG. 3 is a schematic view showing a configuration of inorganic compound particle producing apparatus 100a according to a second exemplary embodiment.

Inorganic compound particle producing apparatus 100a according to the second exemplary embodiment is different from inorganic compound particle producing apparatus 100 according to the first exemplary embodiment in that, as shown in FIG. 3, in second raw material supply unit 30, the first solution and the second solution are supplied as mixed solution 36 obtained by mixing the first solution and the second solution, second mix unit 40a is configured by one second mixer 41, and the mixed solution is mixed with a solution including the produced inorganic compound particles. Other configurations are substantially the same as those of inorganic compound particle producing apparatus 100 according to the first exemplary embodiment. In this case, the concentration of the first solution and the concentration of the second solution are set to be less than the saturation concentration such that the inorganic compound particles are not precipitated at the stage of mixed solution 36 before being supplied to second mix unit 40a.

Consequently, second mix unit 40a can be configured by one second mixer 41, thus allowing downsizing. In addition, it is possible to reduce production instability due to pulsation of the liquid supply unit.

### Examples 7 to 10 and Comparative Examples 4 and 5

Hereinafter, Examples using inorganic compound particle producing apparatus 100a according to the second exemplary embodiment and Comparative Examples, in which sodium hexafluoroaluminate (Na₃AlF₆) as a complex fluoride was produced as inorganic compound particles will be described.

### Example 7

In Example 7, two types of compound solutions were supplied using two plunger pumps as the liquid supply unit of first raw material group 11. Herein, as a compound solution for synthesizing Na₃AlF₆, first solution 12 in which sodium fluoride as a first compound was dissolved in ultrapure water at 48 mM and second solution 13 in which aluminum chloride hexahydrate as a second compound was dissolved in ultrapure water at 40 mM were prepared. Then, the flow rate ratio of second solution 13 to first solution 12 was set to ⅕, and the set flow rate of each plunger pump was adjusted such that the flow rate of the mixed solution was 10 mL/min (flow rate of first solution 12: flow rate of second solution 13=5: 1). In the case of the above flow rate, the concentration of the first compound after mixing the two liquids was 40 mM.

A T-shaped mixer (SUS316 material, inner diameter 0.5 mm) was used as first mixer 20 for first solution 12 and second solution 13.

A plunger pump was also used for the liquid supply unit of second raw material group 31. In second raw material group 31, the mixed solution previously mixed with a first solution obtained by dissolving sodium fluoride as the first compound in ultrapure water at 24 mM and a second solution obtained by dissolving aluminum chloride hexahydrate as the second compound at 20 mM was used. In this case, the volume ratio of the second solution to the first solution is ⅕ (volume of first solution: volume of second solution=5:1), and the concentration of the first compound after mixing the two solutions is 20 mM. This solution was supplied at 10 mL/min.

A T-shaped mixer (SUS316 material, inner diameter 0.5 mm) was also used as second mixer 41 for mixing the first raw material group 11 and second raw material group 31.

The solution mixed in the second mixer passed through a particle detection unit (particle size evaluation unit) provided downstream, and the particle size was evaluated. In Example 7, the target particle size was set to 10 μm, feedback control was performed by controller 60, and the liquid supply flow rate of at least one of first raw material group 11 and second raw material group 31 was adjusted.

### Example 8

In Example 8, inorganic compound particles were fabricated under the same production conditions as in Example 7 except that first solution 12 obtained by dissolving the first compound in ultrapure water at 768 mM and second solution 13 obtained by dissolving the second compound in ultrapure water at 640 mM were used as first raw material group 11. The concentration of the first compound in the solution in which first raw material group 11 is mixed is 640 mM. In addition, in Example 2, the target particle size was set to 250 nm.

### Example 9

In Example 9, inorganic compound particles were fabricated under the same production conditions as in Example 1 except that feedback control was not performed.

### Example 10

In Example 10, inorganic compound particles were fabricated under the same production conditions as in Example 2 except that feedback control was not performed.

### Comparative Example 4

In Comparative Example 4, inorganic compound particles were fabricated under the same production conditions as in Example 7 except that the feedback control was not performed and second raw material group 31 was not used.

### Comparative Example 5

In Comparative Example 5, inorganic compound particles were fabricated under the same production conditions as in Example 8 except that the feedback control was not performed and second raw material group 31 was not used.

### Evaluation)

A case where the deviation of the particle size evaluation value (average particle size) from the target set particle size was within 5% of the target set particle size was evaluated as ⊙, a case where the deviation of the particle size evaluation value from the target set particle size was within 5 to 10% of the target set particle size was evaluated as ◯, and other cases were evaluated as x.

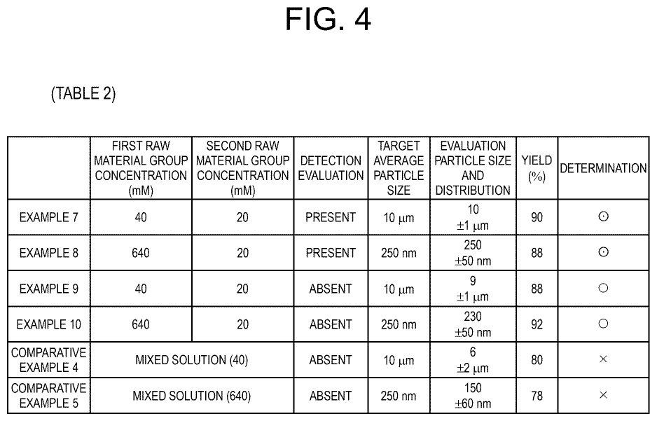

FIG. 4 is Table 2 showing production conditions of inorganic compound particles of Examples 7 to 10 using inorganic compound particle producing apparatus 100 a of FIG. 3 and Comparative Examples 4 and 5 and properties of the obtained inorganic compound particles.

As shown in Table 2 of FIG. 4, in the cases of Examples 7 to 10 using inorganic compound particle producing apparatus 100a having second mix unit 40a in addition to first mix unit 20, it is found that the target average particle size could be achieved within an error range. In contrast, in the cases of Comparative Examples 4 and 5 using inorganic compound particle producing apparatus 100a without providing second mix unit 40a, the target average particle size could not be achieved within an error range.

In addition, comparing Examples 7 and 8 with Examples 9 and 10, it is found that the average particle size of the obtained particles is closer to the target average particle size in consideration of the error and the yield is higher in the case of performing the feedback control using detection evaluation unit 50 and controller 60.

The inorganic compound particle producing apparatus according to the present disclosure can produce inorganic compound particles having a particle size of nm units.

What is claimed is:

1. An inorganic compound particle producing apparatus comprising:
a first raw material supply unit that supplies a first solution and a second solution;
a first mix unit including a first mixer that mixes the first solution and the second solution supplied from the first raw material supply unit to generate a mixed solution;
a second raw material supply unit that supplies a first solution and a second solution; and
a second mix unit located downstream of the first mix unit, the second mix unit mixing the first solution and the second solution supplied from the second raw material supply unit with the mixed solution supplied from the first mixer.

2. The inorganic compound particle producing apparatus according to claim 1, wherein the second raw material supply unit separately supplies the first solution and the second solution to the second mix unit.

3. The inorganic compound particle producing apparatus according to claim 2, wherein
the second mix unit includes:
a second mixer located downstream of the first mix unit, the second mixer mixing the first solution supplied from the second raw material supply unit; and
a third mixer located downstream of the second mixer, the third mixer mixing the second solution supplied from the second raw material supply unit.

4. The inorganic compound particle producing apparatus according to claim 1, wherein the second raw material supply unit supplies, to the second mix unit, a mixed solution obtained by mixing the first solution and the second solution to have a concentration less than or equal to a saturation concentration.

5. The inorganic compound particle producing apparatus according to claim 1, further comprising:
a detection evaluation unit located downstream of the second mix unit, the detection evaluation unit detecting an average particle size of inorganic compound particles generated and precipitated by a reaction between the first solution and the second solution supplied from the first raw material supply unit and the second raw material supply unit; and
a controller that changes a concentration or a supply amount of at least one of the first solution and the second solution supplied from at least one of the first raw material supply unit and the second raw material supply unit based on the average particle size of the inorganic compound particles detected by the detection evaluation unit.

6. The inorganic compound particle producing apparatus according to Claim 1, wherein
the first solution supplied from each of the first raw material supply units and the second raw material supply unit is a solution in which a first compound including fluorine and an alkali metal element is dissolved,
the second solution supplied from each of the first raw material supply units and the second raw material supply unit is a solution in which a second compound including at least one metal element selected from the group consisting of an alkaline earth metal element, aluminum, gallium, indium, zinc, and yttrium is dissolved, and
the inorganic compound particles are complex fluoride composite particles.
